(19) United States
(12) Patent Application Publication
(10) Pub. No.: US 2019/0007180 A1
(43) Pub. Date: Jan. 3, 2019

(54) APPARATUS AND METHOD FOR SUB-CHANNEL SELECTION BASED ON A NUMBER OF ELECTRONIC DEVICES OF A WIRELESS NETWORK

(71) Applicant: QUALCOMM Incorporated, San Diego, CA (US)

(72) Inventors: Kai SHI, San Jose, CA (US); Bin TIAN, San Diego, CA (US); Youhan KIM, Saratoga, CA (US); Rashmi NANDA, Sunnyvale, CA (US); Lochan VERMA, San Diego, CA (US); Ning ZHANG, Saratoga, CA (US)

(21) Appl. No.: 16/022,250

(22) Filed: Jun. 28, 2018

Related U.S. Application Data
(60) Provisional application No. 62/527,460, filed on Jun. 30, 2017.

(51) Int. Cl. H04L 5/00

(52) U.S. Cl. CPC H04L 5/0051; H04L 5/0094; H04W 72/0453; H04L 5/0098; H04L 5/0007; H04L 5/0046

(57) ABSTRACT

This disclosure provides systems, methods and apparatus, including computer programs encoded on computer storage media, for sub-channel selection in a wireless network. In one aspect, a first message is generated at a first electronic device of a wireless network in response to a number of electronic devices of a wireless network being less than a threshold number. The first message indicates particular sub-channels of a transmission band that are to be used for a transmission in a single user (SU) mode of operation to a second electronic device of the wireless network. The method further includes sending the first message to the second electronic device. The first message indicates that a second message is to be sent to the second electronic device using the particular sub-channels. The method further includes sending the second message to the second electronic device via the transmission using the particular sub-channels.

### CROSS REFERENCE TO RELATED APPLICATIONS

The present application claims priority from U.S. Provisional Patent Application No. 62/527,460 entitled “SUB-CHANNEL SELECTION WITH INTERLEAVING FOR AN ELECTRONIC DEVICE,” filed Jun. 30, 2017, which is incorporated herein by reference in its entirety.

### TECHNICAL FIELD

This disclosure is generally related to electronic devices, and more particularly to electronic devices that communicate using a wireless network.

### DESCRIPTION OF RELATED TECHNOLOGY

An electronic device may communicate with one or more other electronic devices using a communication network. For example, a mobile device may use a wireless communication network to communicate with an access point (AP) or with another mobile device. An AP may be connected to one or more other communication networks, such as the Internet.

In some circumstances, a communication network is subject to noise or interference. For example, wireless signals sent and received by a mobile device may be subject to noise and interference from wireless signals of other mobile devices. Some communication protocols enable a mobile device to select channels of a communication network, such as by selecting a channel that is subject to a low amount of interference from other devices.

In some circumstances, bandwidth of a communication network may be unused, which may be inefficient. For example, in some communication protocols, certain combinations of channels are “disallowed,” which may lead to reduced efficiency of resource usage in a communication network. To further illustrate, a particular communication protocol may specify that in certain circumstances only “contiguous” channels (such as channels having a combined frequency range that is continuous) may be used for a particular data transmission. Alternatively or in addition, a particular communication protocol may specify a “power of two” criterion that N channels may be combined for a particular transmission of data, where N is a positive integer that is a power of two. In this case, a device operating based on the particular communication protocol may send data using N channels, such as by sending the data using one channel, two channels, four channels, or eight channels, etc. The particular communication protocol may specify that other combinations of channels (such as three channels, five channels, etc.) are “disallowed.” In some circumstances, certain channels of the communication network may be unused, such as in order to satisfy the “power of two” criterion, reducing throughput of the communication network.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method including generating a first message at a first electronic device of a wireless network in response to a number of electronic devices of the wireless network being less than a threshold number. The first message indicates particular sub-channels of a transmission band that are to be used for a transmission in a single-user (SU) mode of operation to a second electronic device of the wireless network. The transmission band includes a first frequency range corresponding to a first sub-channel of the particular sub-channels, a second frequency range corresponding to a second sub-channel of the particular sub-channels, and a third frequency range corresponding to a third sub-channel of the particular sub-channels, where the second frequency range is adjacent to the first frequency range and the third frequency range. The method further includes sending the first message to the second electronic device. The first message indicates that a second message is to be sent to the second electronic device using the particular sub-channels. The method further includes sending the second message to the second electronic device via the transmission using the particular sub-channels. In some implementations, the method includes avoiding (or “puncturing”) at least one sub-channel of the transmission band based on an indication of one or more radar signals detected using a radar detection circuit.

The method may further include performing, prior to generating the first message, a scanning process to detect signals associated with a plurality of sub-channels that includes the particular sub-channels and at least one other sub-channel and determining, based on the signals, an energy value for each of the plurality of sub-channels. The particular sub-channels may be associated with interference less than an interference threshold. In some implementations, the method further includes determining that the energy values associated with the particular sub-channels are less than the interference threshold and determining that the energy value associated with the at least one other sub-channel exceeds the interference threshold. Determining that the energy values are less than the interference threshold may include squaring amplitudes of the signals to generate the energy values and comparing the energy values to a threshold energy value corresponding to the interference threshold.

In some implementations, the method further includes interleaving data of the second message among the particular sub-channels. To illustrate, the method may further include partitioning the data into a distinct data stream for each of the particular sub-channels and assigning bits of each distinct data stream to the particular sub-channel corresponding to the distinct data stream. In another example, the method further includes partitioning the data into a distinct data stream for each group of adjacent sub-channels of the particular sub-channels and assigning bits of each distinct data stream to the group corresponding to the distinct data stream. In another example, the method further includes assigning bits of the data as a single data stream to the particular sub-channels.

In some implementations, the first message includes a preamble message having a bitmap, and the bitmap includes a bit for each sub-channel of the transmission band. The bitmap may further include one or more additional bits indicating whether sub-channel puncturing is enabled for the transmission. In some implementations, the first message and the second message are sent according to an Institute of Electronics and Electrical Engineers (IEEE) 802.11ax protocol. The second message may be sent using an orthogonal frequency division multiplexing (OFDM) technique specified by the IEEE 802.11ax protocol.

Another innovative aspect of the subject matter described in this disclosure can be implemented in an apparatus including a sub-channel selection circuit configured to determine, in response to a number of electronic devices of a wireless network being less than a threshold number, particular sub-channels of a transmission band. The particular sub-channels are to be used for a transmission in a single user (SU) mode of operation to an electronic device of the wireless network and are associated with interference less than an interference threshold. The transmission band includes a first frequency range corresponding to a first sub-channel of the particular sub-channels, a second frequency range corresponding to a second sub-channel of the particular sub-channels, and a third frequency range corresponding to a third sub-channel of the particular sub-channels, where the second frequency range is adjacent to the first frequency range and the third frequency range. The apparatus further includes a transmitter coupled to the sub-channel selection circuit. The transmitter is configured to send a first message to the electronic device. The first message indicates that a second message is to be sent to the electronic device using the particular sub-channels. The transmitter is further configured to send the second message to the electronic device via the transmission using the particular sub-channels.

In some implementations, the apparatus further includes an interleaver configured to interleave data of the second message among the particular sub-channels. The interleaver may be configured to partition the data into a distinct data stream for each of the particular sub-channels and to assign bits of each distinct data stream to the particular sub-channel corresponding to the distinct data stream. In another example, the interleaver is configured to partition the data into a distinct data stream for each group of adjacent sub-channels of the particular sub-channels and to assign bits of each distinct data stream to the group corresponding to the distinct data stream. In another example, the interleaver is configured to assign bits of the data as a single data stream to the particular sub-channels.

In some implementations, the first message includes a preamble message having a bitmap that includes a bit for each of sub-channel of the transmission band, where a value of a bit for each sub-channel indicates whether the sub-channel is to be used for the transmission. The bitmap may further include one or more additional bits indicating whether sub-channel puncturing is enabled for the transmission.

In some implementations, the apparatus further includes a receiver configured to perform a scanning process to detect signals associated with a plurality of sub-channels that includes the particular sub-channels and at least one other sub-channel. The sub-channel selection circuit may be further configured to determine, based on the signals, an energy value for each of the plurality of sub-channels. In some implementations, the sub-channel selection circuit is further configured to determine that the energy values associated with the particular sub-channels indicate that the interference is less than the interference threshold and to determine that the energy value associated with the at least one other sub-channel exceeds the interference threshold. The sub-channel selection circuit may be further configured to determine that the energy values are less than the interference threshold by squaring amplitudes of the signals to generate the energy values and comparing the energy values to a threshold energy value corresponding to the interference threshold.

In some implementations, the transmitter is further configured to send the first message and the second message according to an Institute of Electronics and Electrical Engineers (IEEE) 802.11ax protocol. The transmitter may be further configured to send the second message using an orthogonal frequency division multiplexing (OFDM) technique specified by the IEEE 802.11ax protocol.

Another innovative aspect of the subject matter described in this disclosure can be implemented in a method including receiving, from a first electronic device of a wireless network and in response to a number of electronic devices of the wireless network being less than a threshold number, a first message at a second electronic device of the wireless network. The first message indicates that a second message is to be sent using particular sub-channels of a transmission band. The transmission band includes a first frequency range corresponding to a first sub-channel of the particular sub-channels, a second frequency range corresponding to a second sub-channel of the particular sub-channels, and a third frequency range corresponding to a third sub-channel of the particular sub-channels, where the second frequency range is adjacent to the first frequency range and the third frequency range. The method further includes receiving the second message at the second electronic device from the first electronic device in a single user (SU) mode of operation and using the particular sub-channels. In some implementations, at least one sub-channel of the transmission band is punctured based on one or more of an amount of interference associated with the at least one sub-channel or one or more radar signals associated with the at least one sub-channel.

Another innovative aspect of the subject matter described in this disclosure can be implemented in an apparatus including a receiver configured to receive, in response to a number of electronic devices of a wireless network being less than a threshold number, a first message from an electronic device of the wireless network. The first message indicates that a second message is to be sent using particular sub-channels of a transmission band. The receiver is further configured to receive the second message from the electronic device using the particular sub-channels and in a single user (SU) mode of operation. The transmission band includes a first frequency range corresponding to a first sub-channel of the particular sub-channels, a second frequency range corresponding to a second sub-channel of the particular sub-channels, and a third frequency range corresponding to a third sub-channel of the particular sub-channels, where the second frequency range is adjacent to the first frequency range and the third frequency range. The apparatus further includes a processor coupled to the receiver. In some implementations, at least one sub-channel of the transmission band is punctured based on one or more of an amount of interference associated with the at least one sub-channel or one or more radar signals associated with the at least one sub-channel.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is a diagram of an illustrative example of a system including a first electronic device that is configured to determine particular sub-channels of a transmission band for a point-to-point transmission to a second electronic device.

FIG. 2 is a diagram depicting certain aspects of illustrative example interleaving schemes that may be used by an electronic device, such as the first electronic device of FIG. 1.

FIG. 3 is a diagram depicting certain aspects of an example of a preamble message that may be sent from the first electronic device of FIG. 1 to the second electronic device of FIG. 1.

FIG. 4 is a flow chart depicting an illustrative example of a method of operation of an electronic device, such as the first electronic device of FIG. 1.

FIG. 5 is a flow chart depicting another illustrative example of a method of operation of an electronic device, such as the second electronic device of FIG. 1.

FIG. 6 is a block diagram of an illustrative example of an electronic device, such as the electronic device of FIG. 1 or the second electronic device of FIG. 1.

Like reference numbers and designations in the various drawings indicate like elements.

### DETAILED DESCRIPTION

Aspects of the disclosure are related to selection of sub-channels of a transmission band by a first electronic device for a transmission (such as a point-to-point transmission) to a second electronic device. The transmission may be performed during operation according to a single-user (SU) mode indicated by a particular communication protocol (instead of during operation according to a multi-user (MU) mode indicated by the communication protocol).

In some implementations, the first electronic device is configured to use non-adjacent (also referred to herein as “non-contiguous”) sub-channels of the transmission band for the transmission. Use of non-adjacent sub-channels may be referred to as “puncturing” the transmission band. By enabling an electronic device to use non-adjacent sub-channels, efficiency of network resource usage may be increased as compared to a technique that requires sub-channels for a transmission to be adjacent and that disallows use of non-adjacent sub-channels (in which case non-adjacent sub-channels may be unused). In some implementations, data is assigned (such as “distributed” or “applied”) to non-adjacent sub-channels by interleaving the data among the non-adjacent sub-channels. Using non-adjacent sub-channels for data transmission enables higher data throughput as compared to a technique that disallows use of non-adjacent sub-channels.

To further illustrate, the first electronic device may be configured to send data via the particular sub-channels, where the data is interleaved using one or more interleaving schemes. In a first example, bits of the data are distributed into distinct streams for each of the particular sub-channels. Each distinct stream may then be interleaved (such as based on an intra-sub-channel interleaving technique). In a second example, bits of the data are distributed into distinct streams for each group of adjacent sub-channels (or for each “segment”). Each distinct stream may then be interleaved (such as using a group-based sub-channel interleaving technique). In a third example, bits of the data are distributed and interleaved among each of the particular sub-channels (such as based on an inter-sub-channel interleaving technique).

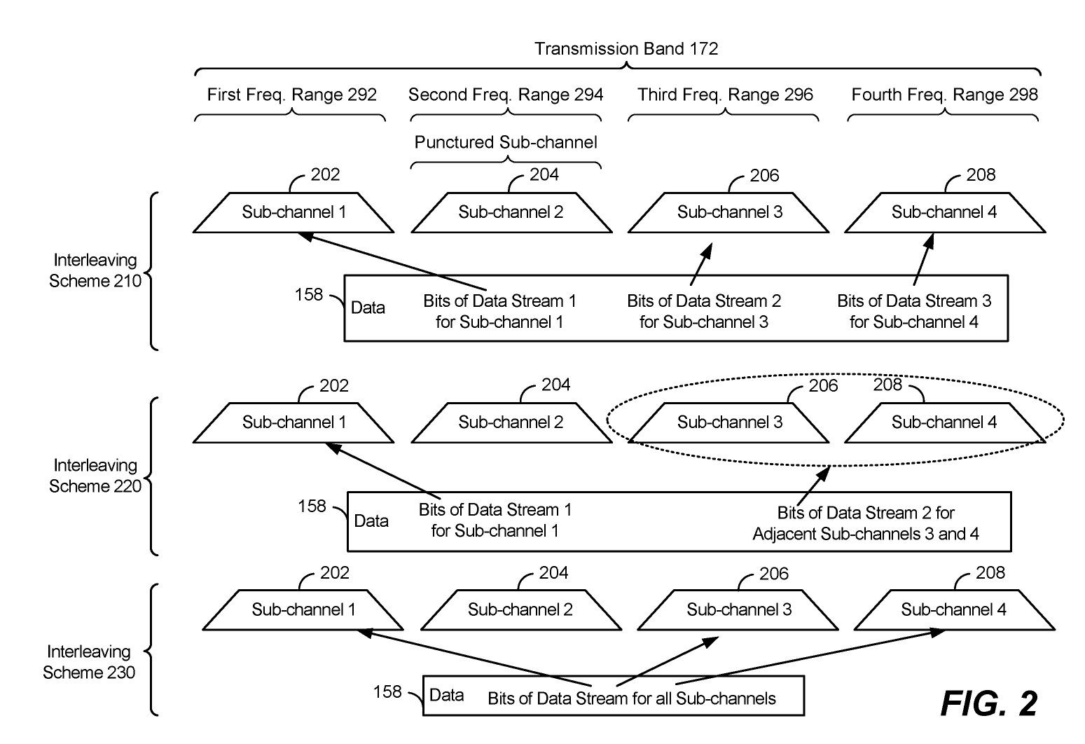

To further illustrate certain advantages and innovative aspects of the disclosure, in some implementations, data to be sent via a transmission may include bits 1, 2, 3, 4, 5, 6, 7, 8, 9, 10, 11, and 12. The data may be sent via sub-channels 1, 2, 3, and 4 of a transmission band, where sub-channels 1 and 2 form segment 1 and sub-channels 3 and 4 form segment 2. In some implementations (such as described with reference to the example of FIG. 2, below), sub-channel 2 is punctured, so that segment 1 includes one sub-channel (sub-channel 1) and segment 2 includes two sub-channels (sub-channels 3 and 4). In this case, sub-channels 1, 3, and 4 are used to send the data, and each sub-channel may be used to send 4 bits.

In a first interleaving scheme, bits may be assigned to sub-channels in another round-robin fashion. For example, bits 1, 4, 7, and 10 may be assigned to sub-channel 1, bits 2 5, 8, and 11 may be assigned to sub-channel 3, and bits 3, 6, 9, and 12 may be assigned to sub-channel 4. After this permutation, bits of each sub-channel may be interleaved, which may be referred to as tone interleaving.

In a second interleaving scheme, bits are assigned to the two segments evenly and in round robin fashion. As a non-limiting illustrative example, bits 1, 3, 5, and 7 may be assigned to segment 1, and bits 2, 4, 6, and 8 may be assigned to segment 2 (which includes sub-channels 3 and 4). Because sub-channel 1 is full, the rest of the bits (bits 9, 10, 11, 12) are assigned to segment 2. After this segment permutation, bits within each segment may be tone interleaved. For example, segment 2 may include bits 2, 4, 6, 8, 9, 10, 11, and 12, and all bits may be block interleaved according to a per-tone basis across all tones of sub-channels 3 and 4.

In a third interleaving scheme, all tones from sub-channels 1, 3 and 4 may be grouped together and tone interleaving may be performed once. In some implementations, the third interleaving scheme may enhance performance but may be associated with complex memory operations (due to interleaving all bits together) and may not be “friendly” to certain hardware. Alternatively, the first and second interleaving schemes may be more “friendly” to certain implementations. As an illustrative example, the first interleaving scheme may be performed according to a per-resource unit (RU) basis, and the third interleaving scheme may be performed according to a per-segment basis that is more complex than the per-RU basis. As another example, in an example of the second interleaving scheme, RU processing may be limited to one RU in each segment, which may be more hardware “friendly” as compared to per-segment processing of the third interleaving scheme.

Thus, an electronic device may “puncture” sub-channels of a transmission band by using a particular interleaving scheme, such as any of the first, second, and third interleaving schemes. The particular interleaving may be selected based on one or more operating criteria. For example, the third interleaving scheme may be selected to increase performance in a wireless network. As another example, the first or second interleaving scheme may be selected to reduce hardware or processing complexity. Other illustrative aspects are described below with reference to the drawings.

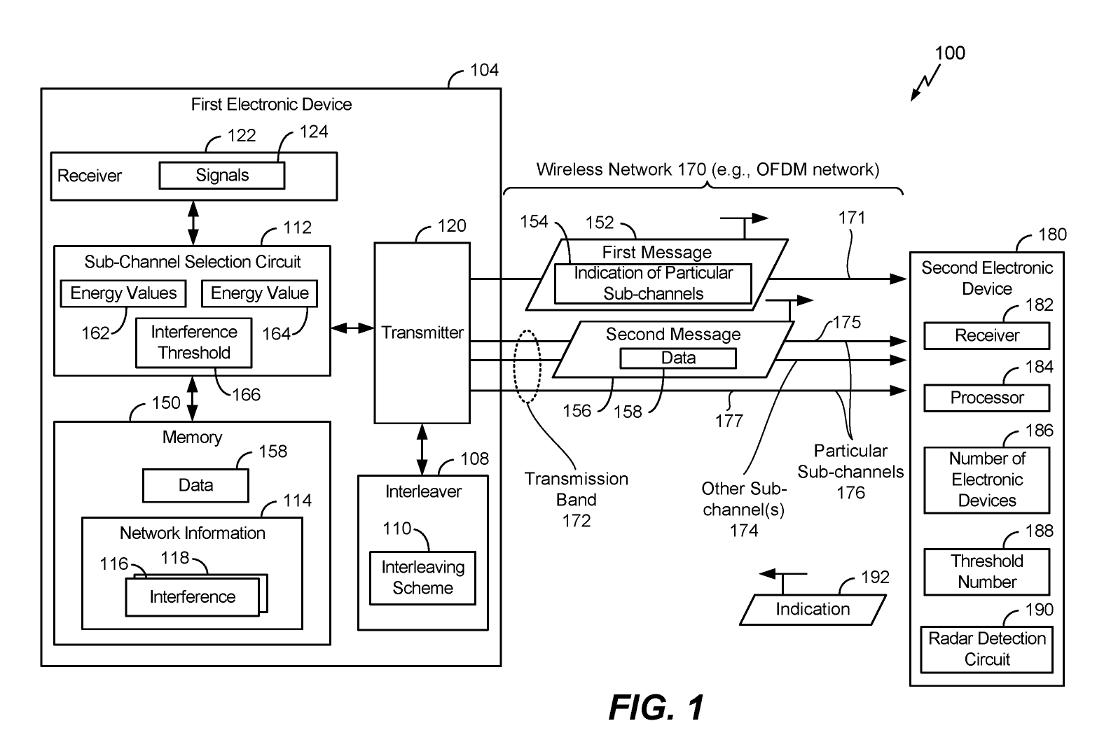

Referring to FIG. 1, an illustrative example of a system (such as a communication system) is depicted and generally designated 100. The system 100 includes a first electronic device 104 and a second electronic device 180. The first electronic device 104 is configured to determine particular sub-channels 176 of a transmission band 172 that are to be used for a point-to-point transmission to the second electronic device 180. In an illustrative example, the first electronic device 104 corresponds to a wireless device (such as a mobile telephone, a laptop computer, a tablet computer, or a wearable device as illustrative examples), and the second electronic device 180 corresponds to an access point. In another illustrative example, the second electronic device 180 corresponds to a wireless device (such as a mobile telephone, a laptop computer, a tablet computer, or a wearable device as illustrative examples), and the first electronic device 104 corresponds to an access point. Alternatively or in addition, the electronic devices 104, 180 may correspond to or include other electronic devices.

In the example of FIG. 1, the first electronic device 104 includes a sub-channel selection circuit 112 and a transmitter 120 coupled to the sub-channel selection circuit 112. The first electronic device 104 may further include a receiver 122, a memory 150, and an interleaver 108. The receiver 122 may be coupled to the sub-channel selection circuit 112, and the interleaver 108 may be coupled to the transmitter 120.

Each of the electronic devices 104, 180 may include one or more processors and one or more memories. For example, the first electronic device 104 may include a memory 150 coupled to the sub-channel selection circuit 112. As another example, the second electronic device 180 may include a processor 184. FIG. 1 also illustrates that the second electronic device 180 may include a receiver 182 coupled to the processor 184.

The first electronic device 104 is configured to communicate with the second electronic device 180 using a wireless network 170 (such as a wireless local area network (WLAN)) that includes the transmission band 172. For example, the wireless network 170 may correspond to a wireless orthogonal frequency division multiplexing (OFDM) network. The transmission band 172 includes the particular sub-channels 176 (such as a sub-channel 175 and a sub-channel 177) and at least one other sub-channel 174. In some implementations, each sub-channel of the transmission band 172 corresponds to a resource unit (RU) associated with a communication protocol.

The first electronic device 104 is configured to send data to the second electronic device 180 via the wireless network 170 using the transmitter 120. The first electronic device 104 may be configured to receive data from the second electronic device 180 via the wireless network 170 using the receiver 122.

During operation, one or more electronic devices of the system 100 may determine a number of electronic devices 186 connected to the wireless network 170. As an illustrative example, FIG. 1 depicts that the second electronic device 180 may determine the number of electronic devices 186. In some implementations, the second electronic device 180 includes (or corresponds to) an access point that is configured to count a number of devices that are authenticated with the access point in order to determine the number of electronic devices 186. Alternatively or in addition, the second electronic device 180 may include (or correspond to) an access point that is configured to count a number of devices that are associated with the access point in order to determine the number of electronic devices 186.

To further illustrate, the second electronic device 180 may include a counter configured to store a value that indicates the number of electronic devices 186. The second electronic device 180 may be configured to increment (or decrement) the value of the counter in response to an electronic device entering (or leaving) the wireless network 170. In some implementations, the second electronic device 180 is configured to increment the value of the counter in response to the first electronic device 104 performing one or more of an authentication procedure with the second electronic device 180 or an association procedure with the second electronic device 180. In some other implementations, the second electronic device 180 is configured to decrement the value of the counter in response to determining that the first electronic device 104 has left the wireless network 170 (such as by determining that no communications have been received from first electronic device 104 within a threshold time interval).

In some implementations, the second electronic device 180 is configured to compare the number of electronic devices 186 to a threshold number 188 to determine whether the number of electronic devices 186 is less than the threshold number 188. In some implementations, the threshold number 188 may correspond to two, and the number of electronic devices 186 may correspond to one. In this example, the second electronic device 180 may determine that the number of electronic devices 186 is less than the threshold number 188. In other examples, one or both of the number of electronic devices 186 and the threshold number 188 may correspond to other numbers.

In some implementations, the second electronic device 180 is configured to communicate with electronic devices of the wireless network 170 based on a multi-user (MU) mode in response to determining that the number of electronic devices 186 satisfies the threshold number 188. In some implementations, the second electronic device 180 may communicate with the first electronic device 104 and one or more other electronic devices of the wireless network 170 using the MU mode in response to the number of electronic devices 186 satisfying the threshold number 188. In some implementations, the satisfying the threshold number 188 may include being greater than, or equal to, the threshold number 188.

The second electronic device 180 may be configured to communicate with one or more electronic devices of the wireless network 170 based on a single-user (SU) mode in response to determining that the number of electronic devices 186 is less than the threshold number 188. In some implementations, the second electronic device 180 may communicate with the first electronic device 104 using the SU mode in response to the number of electronic devices 186 being less than the threshold number 188.

The SU mode and the MU mode may be specified by one or more communication protocols used by electronic devices of the wireless network 170. For example, the SU mode and the MU mode may be specified by an Institute of Electronics and Electrical Engineers (IEEE) protocol, such as an IEEE 802.11ax protocol. In some other implementations, the SU mode and MU mode may be specified by another communication protocol, such as a Network Basic Input/Output System (NetBIOS) over Transmission Control Protocol (TCP)/Internet Protocol (IP) next big thing (NBT) protocol or an NBT-extreme high throughput (EHT) protocol, as an illustrative example. In some implementations, a number of resource units (RUs) may be associated with the SU mode, the MU mode, or both. For example, a communication protocol may specify that in the SU mode a particular electronic device is associated with a single RU for data transmissions. As an example, an IEEE 802.11ax protocol may specify that in a SU mode, an electronic device is associated with a single RU for data transmissions. In some implementations, use of a single RU (instead of multiple RUs) may result in efficient use of bandwidth of the wireless network 170. In connection with the present disclosure, multiple RUs may be associated to a particular electronic device (such as by “puncturing” one or more sub-channels of the transmission band 172) by interleaving data among non-adjacent sub-channels of the transmission band 172 to increase bandwidth usage efficiency, as described further below.

In some implementations, the second electronic device 180 is configured to provide a mode indication to the first electronic device 104 (such as to indicate use of the SU mode or the MU mode). The second electronic device 180 may provide the mode indication to the first electronic device 104 in response to authenticating the first electronic device 104, associating with the first electronic device 104, performing one or more other operations, or a combination thereof. To further illustrate, the mode indication may include one or more bits having either a first value if the number of electronic devices 186 is less than the threshold number 188 or a second value if the number of electronic devices 186 satisfies the threshold number 188. In some implementations, determination that the number of electronic devices 186 is less than the threshold number 188 enables one or more electronic devices of the wireless network 170 to “puncture” one or more sub-channels of the wireless network 170 in connection with a SU mode of operation, as described further below. In some cases, the second electronic device 180 is configured to change from an SU mode to an MU mode (or vice versa) based on one or more devices entering (or leaving) the wireless network 170.

To select one or more sub-channels for data communications with the second electronic device 180, the first electronic device 104 may be configured to determine an amount of interference associated with the one or more sub-channels of the transmission band 172. For example, the first electronic device 104 may be configured to determine a channel clear assessment (CCA) parameter associated with one or more sub-channels of the transmission band 172 to determine which of the one or more sub-channels are available for data transmission. Determining the CCA parameter may including generating a bitmask indicating which sub-channels of transmission band 172 are available (such as where a “1” bit indicates availability of a sub-channel, and where a “0” bit indicates unavailability of a sub-channel).

To further illustrate, the receiver 122 may be configured to perform a scanning process to detect signals 124 associated with a plurality of sub-channels that includes the particular sub-channels 176 and the at least one other sub-channel 174. The sub-channel selection circuit 112 may be configured to determine, based on the signals 124, an energy value for each of the plurality of sub-channels. For example, the sub-channel selection circuit 112 may be configured to determine energy values 162 associated with the particular sub-channels 176 and an energy value 164 associated with the at least one other sub-channel 174.

Each of the energy values 162, 164 may indicate an amount of interference associated with a respective sub-channel of the transmission band 172. For example, by receiving signals 124 using the particular sub-channels 176 and by determining the energy values 162 based on the signals 124, the energy values 162 indicate an amount of interference 116 associated with the particular sub-channels 176. As another example, by receiving at least one of the signals 124 using the at least one other sub-channel 174 and by determining the energy value 164 based on the at least one signal, the energy value 164 indicates an amount of interference 118 associated with the at least one other sub-channel 174.

The sub-channel selection circuit 112 may be configured to determine whether each of the energy values 162, 164 indicates whether interference associated with each corresponding sub-channel of the transmission band 172 exceeds an interference threshold 166. For example, the sub-channel selection circuit 112 may include a comparator circuit configured to compare each of the energy values 162, 164 to the interference threshold 166 to determine whether interference associated with each corresponding sub-channel of the transmission band 172 exceeds the interference threshold 166. In a particular illustrative example, the sub-channel selection circuit 112 is configured to determine that the energy values 162 associated with the particular sub-channels 176 are less than the interference threshold 166 and that the energy value 164 associated with the at least one other sub-channel 174 exceeds the interference threshold 166. To further illustrate, the sub-channel selection circuit 112 may be configured to determine that the energy values 162 are less than the interference threshold 166 by squaring amplitudes of the signals 124 to generate the energy values 162 and comparing the energy values 162 to a threshold energy value corresponding to the interference threshold 166.

Alternatively or in addition, in some implementations, the first electronic device 104 may receive (such as from another electronic device) information indicating interference associated with the transmission band 172. For example, a device may function as a “master” electronic device of the wireless network 170 and may provide network information 114 specifying the interference 116, 118 to the first electronic device 104.

Alternatively or in addition, one or both of the electronic devices 104, 180 may include a radar detection circuit 190 configured to detect radar signals. For example, the radar detection circuit 190 may be configured to scan one or more frequency bands to detect radar signals, such as by scanning a 5 gigahertz (GHz) frequency band, as an illustrative example. The radar detection circuit 190 may be configured to operate based on one or more radar avoidance protocols, such as a dynamic frequency selection (DFS) protocol, as an illustrative example. By operating according to a radar avoidance protocol (such as a DFS protocol), the radar detection circuit 190 may switch operation from a frequency band associated with radar signals (such as a 5 GHz frequency band) to another frequency band.

To further illustrate, if the radar detection circuit 190 detects one or more radar signals in the at least one other sub-channel 174, a decision may be made to operate in a wideband mode and to avoid use of (or “puncture out”) the at least one other sub-channel 174. In some implementations, the second electronic device 180 corresponds to an access point that includes the radar detection circuit 190 and that communicates an indication 192 of the at least one other sub-channel 174 to one or more electronic devices (such as the first electronic device 104) that are connected to the wireless network 170. Upon receiving the indication 192, the first electronic device 104 may avoid communication using the at least one other sub-channel 174, such as by communicating using the particular sub-channels 176 instead of using the at least one other sub-channel 174, as an illustrative example. In some implementations, the indication 192 is included in a beacon frame, such as a beacon frame that advertises the wireless network 170 to electronic devices.

The sub-channel selection circuit 112 is configured to determine the particular sub-channels 176 to be used for a point-to-point transmission to the second electronic device 180. For example, the sub-channel selection circuit 112 may identify the particular sub-channels 176 based on the interference 116 associated with the particular sub-channels 176 being less than the interference threshold 166. In some implementations, the sub-channel selection circuit 112 may exclude the at least one other sub-channel 174 from the point-to-point transmission based on the interference 118 associated with the at least one other sub-channel 174 exceeding the interference threshold 166.

The transmitter 120 is configured to send a first message 152 to the second electronic device 180. The first message 152 indicates that a second message 156 is to be sent to the second electronic device 180 using the particular sub-channels 176. For example, the first message 152 may include an indication 154 (such as a preamble, a bitmap, or both) that indicates the particular sub-channels 176. The indication 154 may enable the second electronic device 180 to tune to receive the second message 156. Particular illustrative aspects of an example of the indication 154 are described further with reference to FIG. 2.

In some implementations, the transmitter 120 is configured to send the first message 152 using a channel 171. The channel 171 may be independent of the particular sub-channels 176 or may be included in the particular sub-channels 176. In some implementations, the channel 171 may correspond to a “primary” channel, such as a primary control channel that is reserved for communication of control information (such as the indication 154). In some other implementations, the channel 171 may correspond to another channel (such as a data channel or another channel). In some implementations, a channel used to send the first message 152 may be selected dynamically. For example, if the first electronic device 104 detects that the channel 171 is busy (or is associated with a large amount of interference), the first electronic device 104 may select another channel of the wireless network 170 for transmission of the first message 152, such as by selecting a “secondary” control channel of the wireless network 170 in response to detecting that the channel 171 is busy (or is associated with a large amount of interference).

To further illustrate, in a non-limiting example, the transmission band 172 includes a plurality of sub-channels, and the indication 154 includes a bitmask of a plurality of bits. Each bit of the plurality of bits may indicate whether a corresponding sub-channel of the plurality of sub-channels is to be used by the first electronic device 104 for a transmission to the second electronic device 180. In some examples, the bitmask corresponds to the bitmask described above with reference to the CCA parameter.

The receiver 182 is configured to receive the first message 152 from the first electronic device 104. The processor 184 may be responsive to information indicated by the first message 152. For example, based on the first message 152, the processor 184 may be configured to tune the receiver 182 to receive the second message 156. To illustrate, the processor 184 may be configured to adjust one or more receive frequencies of the receiver 182 to one or more frequencies associated with the particular sub-channels 176 based on the indication 154.

The transmitter 120 is configured to send the second message 156 to the second electronic device 180 via a point-to-point transmission using the particular sub-channels 176. The second message 156 may include data 158. In some implementations, the interleaver 108 is configured to interleave the data 158 using an interleaving scheme 110 prior to transmission of the second message 156. Particular illustrative aspects of certain examples of the interleaving scheme 110 are described further with reference to FIG. 2.

The receiver 182 is configured to receive the second message 156 via the point-to-point transmission from the first electronic device 104 using the particular sub-channels 176. For example, after tuning the receiver 182 based on the indication 154, the second electronic device 180 may receive the second message 156 from the transmitter 120 of the first electronic device 104.

As used herein, a point-to-point transmission refer to a communication that is performed during a single-user (SU) mode of operation of the first electronic device 104. A point-to-point transmission may be distinct from a transmission during a multi-user (MU) mode of operation of the first electronic device 104.

To illustrate, during operation according to the MU mode, the electronic devices 104, 180 may communicate using frequency multiplexing (such as using orthogonal frequency division multiple access (OFDMA) of an RU, using spatial multiplexing via a multiple-input, multiple-output (MIMO) technique, or a combination thereof). During operation according to the MU mode, the electronic devices 104, 180 may communicate packets to or from multiple electronic devices concurrently. During operation according to the SU mode, the electronic devices 104, 180 may transmit packets from a particular electronic device to another electronic device in the wireless network 170. Certain conventional OFDMA-based MU systems may support channel puncturing by allocating different RUs to each electronic device. In some implementations, channel puncturing in a SU system is enabled for a particular electronic device using one or more of a multiplexing scheme, a coding scheme, or an interleaving scheme.

The first electronic device 104 may be configured to send the messages 152, 156 to the second electronic device 180 using one or more communication protocols. As an illustrative example, the transmitter 120 may be configured to send the messages 152, 156 according to an IEEE protocol, such as an IEEE 802.11ax protocol. In some implementations, the transmitter 120 is configured to send the second message 156 using an OFDM technique specified by the IEEE 802.11ax protocol. Alternatively or in addition, the first electronic device 104 may be configured to send the messages 152, 156 to the second electronic device 180 using one or more other communication protocols.

In some examples, the at least one other sub-channel 174 is adjacent to the sub-channels 175, 177. In this case, the sub-channels 175, 177 are non-contiguous. To illustrate, the transmission band 172 may include a bandwidth of x megahertz (MHz) (where x is a positive number). The sub-channel 175 may correspond to the first (lowest) x/3 MHz of the transmission band 172, the sub-channel 175 may correspond to the third (highest) x/3 MHz of the transmission band 172, and the at least one other sub-channel 174 may correspond to the “middle” x/3 MHz of the transmission band 172 (where the at least one other sub-channel 174 is adjacent to the sub-channels 175, 177, and where the sub-channels 175, 177 are non-contiguous). In this example, use of non-contiguous sub-channels 175, 177 for a point-to-point transmission may be referred to as “puncturing” the transmission band 172. In addition, it is noted that other implementations may utilize a different number of sub-channels other than three sub-channels, a different division of x MHz, or both. As an example, in some implementations, sub-channels may be assigned unequal bandwidths, such as if the sub-channels 175, 177 are each assigned 2x/5 MHz and the at least one other sub-channel 174 is assigned x/5 MHz, as a non-limiting example.

In some examples, the second electronic device 180 is configured to perform one or more operations described with reference to the first electronic device 104. For example, the second electronic device 180 may be configured to send data to the first electronic device 104 by “puncturing” sub-channels of the transmission band 172 (or of another transmission band of the wireless network 170) using one or more techniques described with reference to the first electronic device 104.

Puncturing the transmission band 172 may enable improved performance in a communication system, such as the system 100. For example, by using non-contiguous sub-channels of the transmission band 172, bandwidth may be increased as compared to a communication system that requires contiguous sub-channels for communication. As a result, performance is increased, such as by enabling an increased data rate or a decreased error rate due to increased bandwidth of the transmission band 172 for a point-to-point transmission.

FIG. 2 depicts certain aspects associated with certain illustrative examples of the interleaving scheme 110 of FIG. 1. For example, the interleaving scheme 110 of FIG. 1 may correspond to one or more of a first interleaving scheme 210, a second interleaving scheme 220, or a third interleaving scheme 230. One or more of the interleaving schemes 210, 220, and 230 may be applied by the interleaver 108 of FIG. 1 to interleave the data 158. For example, the interleaver 108 of FIG. 1 may be configured to interleave the data 158 among the particular sub-channels 176 using a particular interleaving scheme of the interleaving schemes 210, 220, and 230.

FIG. 2 illustrates that the transmission band 172 includes multiple sub-channels, such as a first sub-channel 202, a second sub-channel 204, a third sub-channel 206, and a fourth sub-channel 208. In a particular non-limiting illustrative example, the first sub-channel 202 corresponds to the sub-channel 175, the second sub-channel 204 corresponds to the at least one other sub-channel 174, the third sub-channel 206 corresponds to the sub-channel 177, and the fourth sub-channel 208 corresponds to another sub-channel of the particular sub-channels 176. The first sub-channel 202 may be referred to as a first segment, and the sub-channels 206, 208 may be referred to as a second segment. In some communication protocols, the sub-channels 202, 204, 206, and 208 may be referred to as a resource unit (RU). The sub-channels 202, 204, 206, and 208 may each be associated with a common bandwidth (such as 20 MHz, as an illustrative example) or with different respective bandwidths (such as 20 MHz, 40 MHz, 80 MHz, and 160 MHz, as an illustrative example). In other implementations, the sub-channels 202, 204, 206, and 208 may be different than the example illustrated in FIG. 2. For example, in some implementations that comply with an NBT-EHT protocol, sixteen sub-channels may be used over a frequency range of 320 MHz.

In accordance with the first interleaving scheme 210, the interleaver 108 may be configured to partition the data 158 into a distinct data stream for each of the particular sub-channels 176 and to distribute bits of each distinct data stream to the particular sub-channel 176 that corresponds to the distinct data stream. For example, the interleaver 108 may be configured to partition the data 158 into data stream 1, data stream 2, and data stream 3. The interleaver 108 may be configured to distribute bits of data stream 1 to the first sub-channel 202, to distribute bits of data stream 2 to the third sub-channel 206, and to distribute bits of data stream 3 to the fourth sub-channel 208.

To further illustrate aspects of an example of the first interleaving scheme 210, the data 158 of FIG. 1 may include a plurality of bits that includes bits 0, 1, 2, 3, 4, 5, 6, 7, and 8. To interleave the data 158 based on the first interleaving scheme 210, the first electronic device may group bits 0, 1, and 2 into data stream 1, bits 3, 4, and 5 into data stream 3, and bits 6, 7, and 8 into data stream 3. The first electronic device 104 may interleave bits of data stream 1 to form interleaved data stream 1 (such as by reordering bits 0, 1, and 2 to bits 1, 2, and 0), bits of data stream 2 to form interleaved data stream 2 (such as by reordering bits 3, 4, and 5 to bits 4, 5, and 3), and bits of data stream 3 to form interleaved data stream 3 (such as by reordering bits 6, 7, and 8 to bits 7, 8, and 6). The interleaved data streams may each be mapped to one or more symbols of a modulation or coding scheme, such as symbols of an OFDM scheme. For example, interleaved data stream 1 may be mapped to a first symbol, interleaved data stream 2 may be mapped to a second symbol, and interleaved data stream 3 may be mapped to a third symbol. The symbols may be sent to the second electronic device 180 via the second message 156.

In accordance with the second interleaving scheme 220, the interleaver 108 is configured to partition the data 158 into a distinct data stream for each group of adjacent sub-channels (or for each “segment”) of the particular sub-channels 176 and to distribute bits of each distinct data stream to the group corresponding to the distinct data stream. To illustrate, in FIG. 2, the sub-channels 206, 208 are adjacent, and the interleaver 108 may distribute bits of data stream 2 to a group that includes the sub-channels 206, 208. The interleaver 108 may distribute bits of data stream 1 to the first sub-channel 202.

To further illustrate aspects of an example of the second interleaving scheme 220, the data 158 of FIG. 1 may include a plurality of bits that includes bits 0, 1, 2, 3, 4, 5, 6, 7, 8, and 9. To interleave the data 158 based on the second interleaving scheme 220, the first electronic device may group bits 0-4 into data stream 1 and bits 5-9 into data stream 2. The first electronic device 104 may interleave bits of data stream 1 to form interleaved data stream 1 (such as by reordering bits 0, 1, 2, 3, and 4 to bits 1, 2, 3, 4, and 0) and bits of data stream 2 to form interleaved data stream 2 (such as by reordering bits 5, 6, 7, 8, and 9 to form bits 6, 7, 8, 9, and 5). The interleaved data streams may each be mapped to one or more symbols of a modulation or coding scheme, such as symbols of an OFDM scheme. For example, interleaved data stream 1 may be mapped to a first symbol, and interleaved data stream 2 may be mapped to a second symbol. The symbols may be sent to the second electronic device 180 via the second message 156.

In accordance with the third interleaving scheme 230, the interleaver 108 is configured to distribute bits of the data 158 as a single data stream to the particular sub-channels 176. For example, the interleaver 108 may interleave the data 158 among each of the sub-channels 202, 206, and 208.

To further illustrate aspects of an example of the third interleaving scheme 230, the data 158 of FIG. 1 may include a plurality of bits that includes bits 0, 1, 2, 3, 4, 5, 6, 7, 8, and 9. To interleave the data 158 based on the second interleaving scheme 220, the first electronic device may interleave the plurality of bits to generate an interleaved data stream (such as by interleaving bits 0, 1, 2, 3, 4, 5, 6, 7, and 8 to bits 1, 2, 3, 4, 5, 6, 7, 8, and 0). The interleaved data stream may each be mapped to one or more symbols of a modulation or coding scheme, such as symbols of an OFDM scheme. The one or more symbols may be sent to the second electronic device 180 via the second message 156.

In some implementations, the first electronic device 104 is configured to use an interleaving scheme to interleave low-density parity-check (LDPC) symbols of an LDPC code. To illustrate, the first electronic device 104 may include an encoder configured to encode the data 158 in accordance with an LDPC code. Encoding the data 158 in accordance with the LDPC code may include performing a first interleaving (such as an intra-codeword interleaving) of the data 158. After encoding the data 158 to generate LDPC symbols, the first electronic device 104 may interleave the LDPC symbols (such as by performing an inter-codeword interleaving) using one or more techniques described with reference to FIG. 2. The first electronic device 104 may assign the interleaved LDPC symbols to symbols of a modulation or coding scheme, such as an OFDM scheme, to be sent to the second electronic device 180 (such as within the second message 156).

In one implementation, the first electronic device 104 performs interleaving separately for each non-punctured RU of multiple RUs to be used to transmit the second message 156 (such as on a “intra-RU”) basis. In a first example, the first electronic device 104 may assign bits of the data 158 to multiple RUs on a “first come” basis. For example, in response to a segment being “full” of bits, remaining bits may be assigned to another segment (such as by “filling” a smaller segment first and then by applying any remaining bits to a larger segment, etc.). In a second example, bits may be assigned to segments in a rate proportional to a rate of each segment. In a third example, bits may be assigned in a lower segment and subsequently applied to an upper segment.

In another implementation, the first electronic device 104 performs interleaving on an “inter-RU” basis for multiple non-punctured RUs to be used to transmit the second message 156. For example, multiple non-punctured RUs used to transmit the second message 156 of FIG. 1 may be grouped, and interleaving may be applied to the non-punctured RUs.

The example of FIG. 2 also depicts that each sub-channel of the transmission band 172 includes multiple frequency ranges corresponding to respective sub-channels. As a non-limiting illustrative example, each of the multiple frequency ranges may include 20 MHz centered around a respective center frequency. To further illustrate, the transmission band 172 includes a first frequency range 292 corresponding to the first sub-channel 202, a second frequency range 294 corresponding to the second sub-channel 204, a third frequency range 296 corresponding to the third sub-channel 206, and a fourth frequency range 298 corresponding to the fourth sub-channel 208. The example of FIG. 2 depicts that the second frequency range 294 is adjacent to the first frequency range 292 and the third frequency range 296. As a result, the first frequency range 292 is non-adjacent to the third frequency range 296. Use of the first sub-channel 202 and the third sub-channel 206 for a transmission without use of the second sub-channel 204 is therefore referred to herein as “puncturing” the second sub-channel 204.

Although certain examples herein are described separately for convenience, it will be appreciated that certain aspects of the disclosure may be combined. For example, certain aspects of the interleaving schemes 210, 220, and 230 may be combined. As an illustrative example, segment parsing may be performed as described with reference to the first interleaving scheme 210 (such as by assigning bits to segments as described with reference to the first interleaving scheme 210), and tone interleaving may be performed as described with reference to the second interleaving scheme 220 (such as by interleaving all tones within each segment after assigning bits to the segments).

The examples of FIG. 2 illustrate certain interleaving schemes that may be selected based on the particular application. As an illustrative example, an “intra-RU” interleaving scheme may be selected to enable parallel interleaving operations (such as by performing interleaving of each RU independently). In other cases, an “inter-RU” interleaving scheme may be selected, such as in order to decrease correlation of data sent via the wireless network 170 of FIG. 1.

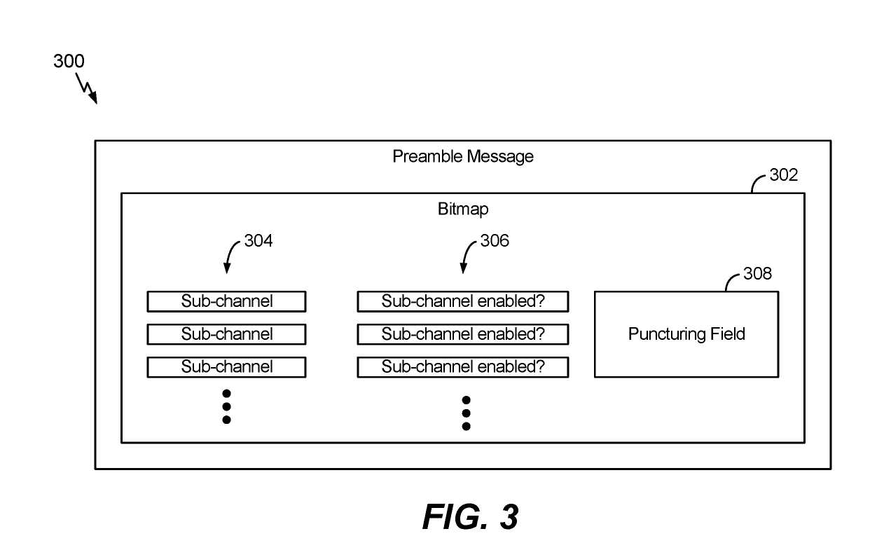

FIG. 3 illustrates aspects of a particular example of a preamble message 300. For example, the preamble message 300 may correspond to (or may be included in) the first message 152 of FIG. 1.

In FIG. 3, the preamble message 300 includes a bitmap 302. The bitmap 302 may include a bit for each sub-channel of the transmission band 172, and a value of a bit for each sub-channel may indicate whether the sub-channel is to be used for a point-to-point transmission. To illustrate, the bitmap 302 may include a plurality of bits 304, where each of the plurality of bits 304 corresponds to a respective sub-channel of the transmission band 172. The bitmap 302 may further include a plurality of bits 306, where each of the plurality of bits 306 indicates whether a corresponding sub-channel of the transmission band 172 is to be used for a point-to-point transmission. To further illustrate, the bits 304, 306 may indicate that the particular sub-channels 176 are to be used for the point-to-point transmission and that the at least one other sub-channel 174 is not to be used for the point-to-point transmission. In some example, the plurality of bits 306 correspond to the indication 154 of FIG. 1.

The bitmap 302 may further include a puncturing field 308 (such as one or more additional bits) indicating whether sub-channel puncturing is enabled for the point-to-point transmission. In some implementations, a first value (such as a logic “1” value or a logic “0” value) of the puncturing field 308 indicates that sub-channel puncturing is enabled (such as where the at least one other sub-channel 174 is to be “punctured”), and a second value (such as a logic “0” value or a logic “1” value) of the puncturing field 308 indicates that sub-channel puncturing is not enabled.

The preamble message 300 may include other information alternatively or in addition to the aspects depicted in FIG. 3. For example, the preamble message 300 may include one or more signal (SIG) fields, such as one or more of a high-efficiency SIG (HE-SIG-A) field or another high-efficiency SIG (HE-SIG-B) field. In a particular illustrative example, one or more aspects of the preamble message 300 may be indicated using the HE-SIG-B field. As a particular example, one or more of aspects of the bitmap 302 may be indicated by the HE-SIG-B field. In another example, one or more aspects of the preamble message 300 may be indicated using the HE-SIG-A field.

In some examples, the puncturing field 308 includes a plurality of bits indicating a selectable channel puncturing mode in connection with a SU mode of operation. To further illustrate, Table 1 indicates certain examples of values of the puncturing field 308 and selectable channel puncturing modes associated with the values. One or more aspects of Table 1 may be used in connection with puncturing associated with one or more of a primary channel, such as Pri20, and a secondary channel, such as Sec80. The example of Table 1 also indicates certain illustrative examples of HE-SIG-B processing associated with the values that may be used during an SU mode of operation.

TABLE 1

| Value of | | |
|---|---|---|
| Puncturing Field | | HE-SIG-B |
| 308 | Channel Puncturing Mode | Processing |
| 0 | 20 MHz (no puncturing) | |
| 1 | 40 MHz (no puncturing) | |
| 2 | 80 MHz (no puncturing) | |
| 3 | 16/80 + 80 MHz (no puncturing) | |
| 4 | 80 MHz (Sec20 punctured) | Use 20_0 and 20_3 |
| 5 | 80 MHz (Sec20 not punctured) | Use 20_0 and 20_1 |
| 6 | 160/80 + 80 MHz (Sec20 | Use 20_0 and 20_3 |
| | punctured in Pri80) | |
| 7 | 160/80 + 80 (Sec20 not | Use 20_0 and 20_1 |
| | punctured in Pri80) | |

Table 1 illustrates that a particular value of the puncturing field 308 may indicate whether puncturing is to be used in a message. For example, values 0, 1, 2, and 3 may indicate that the second message 156 is to be transmitted without puncturing and using a 20 MHz sub-channel, a 40 MHz sub-channel, an 80 MHz sub-channel, or an 80+80 sub-channel (or group of sub-channels). In a non-limiting illustrative example, the 20 MHz sub-channel corresponds to the sub-channel 175, the 40 MHz sub-channel corresponds to the sub-channel 177, the 80 MHz sub-channel corresponds to the at least one other sub-channel 174, and the 80+80 sub-channel corresponds to another sub-channel of the transmission band 172. In some implementations, the value of the puncturing field 308 is indicated using a three-bit value.

Table 1 also depicts that a particular value of the puncturing field 308 indicates certain aspects of the HE-SIG-B field. For example, values 4, 5, 6, and 7 indicate whether the HE-SIG-B field is to be transmitted using a first sub-channel (or group of sub-channels) (such as “20_0 and 20_3”) or a second sub-channel (or group of sub-channels) (such as “20_0 and 20_1”).

To further illustrate, in a first example, the preamble message 300 has an SU physical layer convergence procedure (PLCP) protocol data unit (PPDU) format. In this example, an HE-SIG-A field may include one or more aspects of the preamble message 300. For example, the HE-SIG-A field may include the puncturing field 308. In a second example, the preamble message 300 has an MU PPDU preamble format. In this example, an HE-SIG-A field indicates a particular mode of Table 1 (such as by setting the puncturing field 308 to a particular value illustrated in Table 1), and an HE-SIG-B field indicates that each RU of a plurality of RUs are assigned to the first electronic device 104.

The preamble message 300 of FIG. 3 may be used to improve operation of a communication system. For example, the preamble message 300 may enable sub-channel puncturing, which may improve bandwidth usage efficiency in a communication system.

In some implementations, CCA-based sub-channel selection may be performed (such as described with reference to FIG. 1) using non-adjacent sub-channels. For example, instead of using a contiguous “chunk” of frequency bands selected from 20 MHz, 40 MHz, 80 MHz, and 160 MHz frequency bands (such as by using the 20 MHz and 40 MHz frequency bands), a technique in accordance with aspects of the disclosure may use non-contiguous frequency bands for a transmission in a SU mode, such as by using a combination of 20 MHz and 20 MHz frequency bands, 40 MHz and 40 MHz frequency bands, 20 MHz and 40 MHz frequency bands, 40 MHz and 80 MHz frequency bands, 40 MHz and 80 MHz frequency bands, 20 MHz, 20 MHz, and 20 MHz frequency bands, or any other combination of frequency bands. Combining non-contiguous frequency bands (and “puncturing” one or more sub-channels associated with interference) may be performed in connection with CCA-based per-packet dynamic operation, operation according to a radar avoidance protocol (such as a DFS protocol), one or more other operations, or a combination thereof. In some implementations, channel selection based on a radar avoidance protocol may be performed less frequently as compared to channel selection based on another interference-based channel selection technique, such as a CCA-based channel selection technique.

Although certain examples herein are described with reference to the first message 152 and the preamble message 300, in some other implementations, an “implicit” sub-channel selection signaling method may be used (instead of the first message 152 and the preamble message 300). For example, instead of using the first message 152 or the preamble message 300 to determine one or more particular sub-channels with which to receive the second message 156, the second electronic device 180 may scan one or more sub-channels of the transmission band 172 to detect one or more sub-channels of the transmission band 172 used to transmit the second message 156. Further, depending on the particular implementation, the messages 152 and 156 may be included in a single communication (such as by using a continuous transmission) or may correspond to distinct communications (such as by using separate transmissions for the messages 152 and 156).

Further, although certain examples are described with reference to the threshold number 188 corresponding to a value of two, in other implementations, the threshold number 188 may correspond to a different value. To illustrate, the threshold number 188 may correspond to an integer greater than two (such as three or four or five, etc.). In this example, the second electronic device 180 may initiate (or maintain) an SU mode of operation in response to detecting multiple devices of the wireless network 170. In some circumstances, initiating (or maintaining) an SU mode of operation may be more efficient than initiating (or changing to) an MU mode of operation, such as where use of an SU mode for a relatively low number of devices (such as two, three or four devices) results in more efficient use of network resources as compared to use of an MU mode. Accordingly, in some implementations, the threshold number 188 may correspond to an integer greater than two.

One or more aspects described herein may be used in connection with a request to send (RTS) message, a clear to send (CTS) message, or a combination thereof. For example, an RTS message sent by an initiator device (such as the first electronic device 104) may be transmitted to a recipient device (such as the second electronic device 180) using a channel puncturing technique. Alternatively or in addition, the recipient device may send a CTS message to the initiator device using a channel puncturing technique. In some implementations, the first message 152 or the preamble message 300 may include (or be included in) the RTS message, and the second electronic device 180 may send the CTS message to the first electronic device 104 using sub-channels (such as the particular sub-channels 176) specified by the indication 154 or the plurality of bits 306. In some examples, the second message 156 may be transmitted using different sub-channels of the transmission band 172 than sub-channels used to send the first message 152 or the preamble message 300 (such as to avoid “collision” between the second message 156 and the first message 152 or the preamble message 300).

In some implementations, one or both of the RTS message or the CTS message are specified by a communication protocol, such as an IEEE communication protocol. In some communication protocols, RTS messages or CTS messages may have a particular data length, such as a data length of two bits, as an illustrative example. In this case, the RTS message or the CTS message may be “expanded” in order to indicate more than two sub-channels of the transmission band 172. As a particular example, the RTS message or the CTS message may be “expanded” by including information indicating sub-channels of the transmission band 172 using bits of an address field of the RTS message or the CTS message. In other implementations, an “implicit” signaling technique is used. For example, a recipient device may scan each sub-channel of the transmission band 172 to detect which one or more sub-channels of the transmission band 172 used to send information, such as an RTS message. As another example, an initiator device may scan each sub-channel of the transmission band 172 to detect one or more sub-channels of the transmission band 172 used to send information, such as a CTS message.

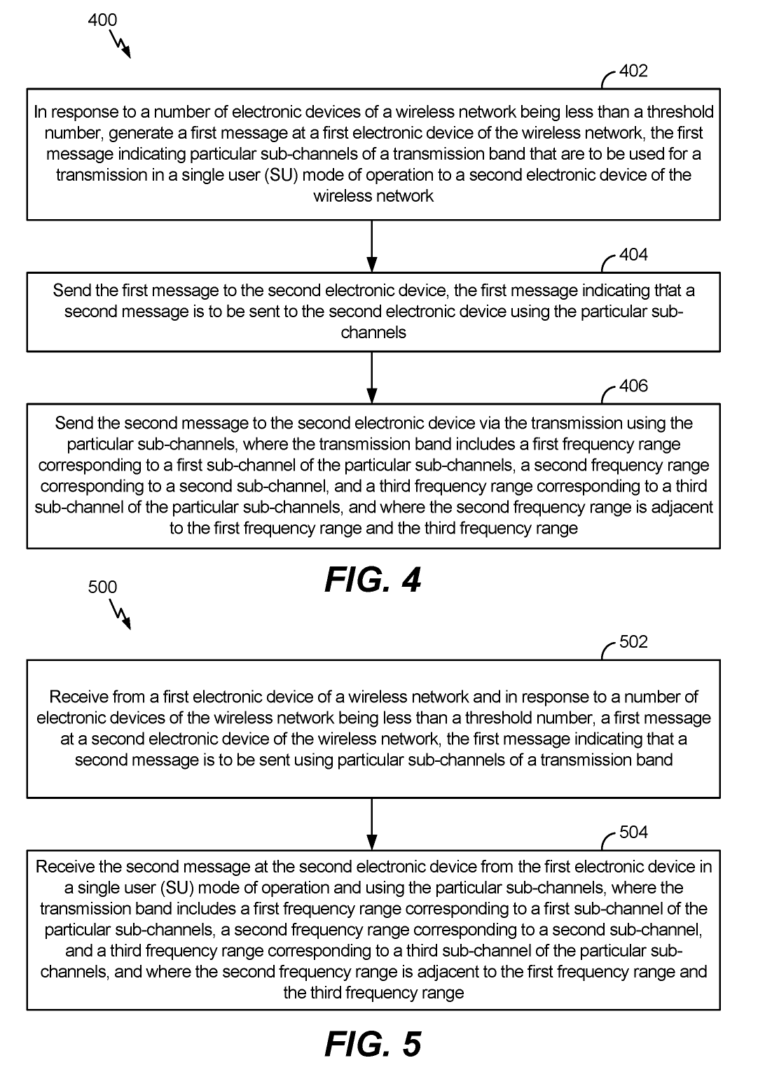

Referring to FIG. 4, a particular example of a method of operation of an electronic device is depicted and generally designated 400. In some implementations, the method 400 is performed by a wireless device, such as a mobile telephone, a laptop computer, or a tablet computer, as illustrative examples. Alternatively or in addition, the method 400 may be performed by an access point. To further illustrate, in some implementations, the method 400 can be performed by the first electronic device 104 of FIG. 1.

The method 400 includes generating a first message at a first electronic device of a wireless network, at 402. The first message is generated in response to a number of electronic devices of the wireless network being less than a threshold number. The first message indicates particular sub-channels of a transmission band that are to be used for a transmission to a second electronic device of the wireless network. For example, the first message 152 may indicate (such as via one or more of the indication 154 or the bitmap 302) the particular sub-channels 176 to be used for a transmission in a single user (SU) mode of operation to the second electronic device 180. The first electronic device 104 may select the particular sub-channels 176 in response to determining that the energy values 162 indicate that the interference 116 is less than the interference threshold 166.

The method 400 further includes sending the first message to the second electronic device, at 404. The first message indicates that a second message is to be sent to the second electronic device using the particular sub-channels. For example, one or more of the indication 154 or the bitmap 302 may indicate that the second message 156 is to be sent using the particular sub-channels 176.

The method 400 further includes sending the second message to the second electronic device via the transmission using the particular sub-channels, at 406. For example, the first electronic device 104 may send the second message 156 to the second electronic device 180 using the particular sub-channels 176. The transmission band includes a first frequency range corresponding to a first sub-channel of the particular sub-channels, a second frequency range corresponding to a second sub-channel, and a third frequency range corresponding to a third sub-channel of the particular sub-channels, where the second frequency range is adjacent to the first frequency range and the third frequency range. For example, the transmission band 172 may include the first frequency range 292, the second frequency range 294, and the third frequency range 296, where the second frequency range 294 is adjacent to the first frequency range 292 and the third frequency range 296.

In some implementations, the method 400 further includes avoiding at least one sub-channel of the transmission band based on an indication of one or more radar signals detected using a radar detection circuit. For example, the first electronic device 104 may be configured to avoid communicating using the at least one other sub-channel 174 in response to receiving the indication 192 of FIG. 1. Alternatively or in addition, the at least one sub-channel 174 may be avoided based on the amount of interference 118 associated with the at least one other sub-channel 174 being greater than, or greater than or equal to, the interference threshold 166. Thus, at least one sub-channel of the transmission band 172 may be punctured based on one or more of an amount of interference associated with the at least one sub-channel or one or more radar signals associated with the at least one sub-channel.

The method 400 may improve bandwidth usage efficiency in a communication system.

As a result, performance may be enhanced.

Referring to FIG. 5, a particular example of a method of operation of an electronic device is depicted and generally designated 500. In some implementations, the method 500 is performed by the second electronic device 180 of FIG. 1.

The method 500 includes receiving, from a first electronic device of a wireless network and in response to a number of electronic devices of the wireless network being less than a threshold number, a first message at a second electronic device of the wireless network, at 502. The first message indicates that a second message is to be sent using particular sub-channels of a transmission band. For example, the second electronic device 180 may receive the first message 152 from the first electronic device 104, and the first message 152 may indicate the particular sub-channels 176 (such as via the indication 154 or the bitmap 302). The particular sub-channels 176 may be associated with the interference 116 that is less than the interference threshold 166.

The method 500 further includes receiving the second message at the second electronic device from the first electronic device in a single user (SU) mode of operation and using the particular sub-channels, at 504. For example, the second electronic device 180 may receive the second message 156 from the first electronic device 104 using the particular sub-channels 176. The transmission band includes a first frequency range corresponding to a first sub-channel of the particular sub-channels, a second frequency range corresponding to a second sub-channel, and a third frequency range corresponding to a third sub-channel of the particular sub-channels, where the second frequency range is adjacent to the first frequency range and the third frequency range. For example, the transmission band 172 may include the first frequency range 292, the second frequency range 294, and the third frequency range 296, where the second frequency range 294 is adjacent to the first frequency range 292 and the third frequency range 296.

In some implementations, the method 500 further includes avoiding at least one sub-channel of the transmission band based on an indication of one or more radar signals detected using a radar detection circuit. For example, the first electronic device 104 may be configured to avoid communicating using the at least one other sub-channel 174 in response to receiving the indication 192 of FIG. 1, and the second electronic device 180 may receive the second message 156 from the first electronic device 104 without use of the at least one other sub-channel 174. Alternatively or in addition, the at least one sub-channel 174 may be avoided based on the amount of interference 118 associated with the at least one other sub-channel 174 being greater than, or greater than or equal to, the interference threshold 166. Thus, at least one sub-channel of the transmission band 172 may be punctured based on one or more of an amount of interference associated with the at least one sub-channel or one or more radar signals associated with the at least one sub-channel.

The method 500 may improve bandwidth usage efficiency in a communication system. As a result, performance may be enhanced.

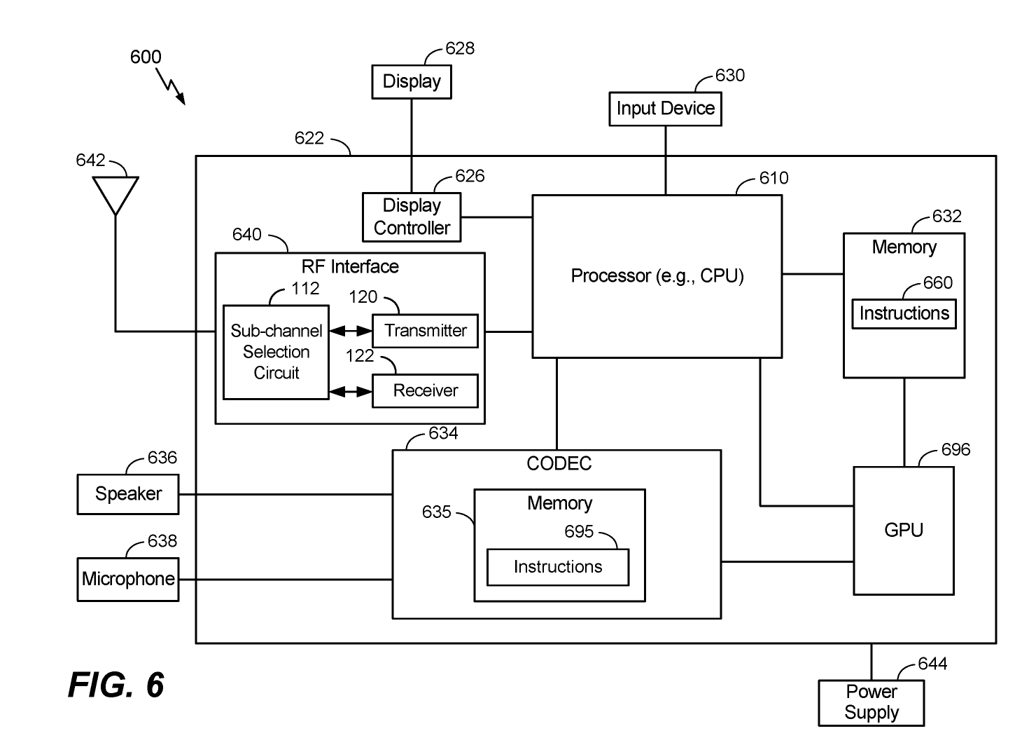

In some implementations, one or more operations of the methods 400, 500 are performed, initiated, or controlled by a processor that executes instructions. Certain illustrative aspects of a processor that executes instructions are described further with reference to FIG. 6

Referring to FIG. 6, a block diagram of a particular illustrative example of an electronic device is depicted and generally designated 600. In an illustrative example, the electronic device 600 corresponds to the first electronic device 104. Alternatively or in addition, one or more aspects of the electronic device 600 may be implemented in the second electronic device 180. Depending on the particular implementation, one or more aspects of the electronic device 600 may be implemented in a mobile device (such as a cellular phone), a computer (such as a server, a laptop computer, a tablet computer, or a desktop computer), a base station, a wearable electronic device (such as a personal camera, a head-mounted display, or a watch), a vehicle control system or console, an autonomous vehicle (such as a robotic car or a drone), a home appliance, a set top box, an entertainment device, a navigation device, a personal digital assistant (PDA), a television, a monitor, a tuner, a radio (such as a satellite radio), a music player (such as a digital music player or a portable music player), a video player (such as a digital video player, such as a digital video disc (DVD) player or a portable digital video player), a robot, a healthcare device, another electronic device, or a combination thereof.

The electronic device 600 includes one or more processors, such as a processor 610 and a graphics processing unit (GPU) 696. The processor 610 may include a central processing unit (CPU), another processing device, or a combination thereof.

The electronic device 600 may further include one or more memories, such as a memory 632. The memory 632 may be coupled to the processor 610, to the GPU 696, or to both. The memory 632 may include random access memory (RAM), magnetoresistive random access memory (MRAM), flash memory, read-only memory (ROM), programmable read-only memory (PROM), erasable programmable read-only memory (EPROM), electrically erasable programmable read-only memory (EEPROM), one or more registers, a hard disk, a removable disk, a compact disc read-only memory (CD-ROM), another memory device, or a combination thereof.

The memory 632 may store instructions 660. The instructions 660 may be executable by the processor 610, by the GPU 696, or by both. The instructions 660 may be executable to perform, initiate, or control one or more operations described herein. For example, in some implementations, the instructions 660 are executable by the processor 610 or the GPU 696 to perform, initiate, or control one or more operations of the method 400 of FIG. 4, one or more operations of the method 500 of FIG. 5, or a combination thereof. Alternatively or in addition, one or more operations described herein may be performed, initiated, or controlled by one or more other components of the electronic device 600.

In an illustrative example, the electronic device 600 includes a radio frequency (RF) interface 640 (such as a transceiver device) that includes the sub-channel selection circuit 112, the transmitter 120, and the receiver 122. The RF interface 640 may be coupled to an antenna 642.

A coder/decoder (CODEC) 634 also can be coupled to the processor 610. The CODEC 634 may be coupled to one or more microphones, such as a microphone 638. The CODEC 634 may be coupled to one or more speakers, such as a speaker 636. The CODEC 634 may include a memory 635. The memory 635 may store instructions 695 executable by the CODEC 634.

The electronic device 600 may further include a display 628, such as a touchscreen display, as an illustrative example. FIG. 6 also shows a display controller 626 that is coupled to the processor 610 and to the display 628.

In some implementations, the processor 610, the GPU 696, the memory 632, the display controller 626, the CODEC 634, and the RF interface 640 are included in a system-on-chip (SoC) device 622. Further, an input device 630 and a power supply 644 may be coupled to the SoC device 622. Moreover, in some implementations, as illustrated in FIG. 6, the display 628, the input device 630, the speaker 636, the microphone 638, the antenna 642, and the power supply 644 are external to the SoC device 622. However, each of the display 628, the input device 630, the speaker 636, the microphone 638, the antenna 642, and the power supply 644 can be coupled to a component of the SoC device 622, such as to an interface or to a controller.

As used herein, “coupled” may include communicatively coupled, electrically coupled, magnetically coupled, physically coupled, optically coupled, and combinations thereof. Two devices (or components) may be coupled (such as communicatively coupled, electrically coupled, or physically coupled) directly or indirectly via one or more other devices, components, wires, buses, networks (such as a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive electrical signals (digital signals or analog signals) directly or indirectly, such as via one or more wires, buses, networks, etc.

As used herein, “determining” may include one or more of generating, calculating, using, selecting, or accessing. For example, determining a value, a characteristic, a parameter, or a signal may include actively generating or calculating a value, a characteristic, a parameter, or a signal or may include using, selecting, or accessing a value, a characteristic, a parameter, or a signal that is already generated, such as by a component or a device.

The foregoing disclosed devices and functionalities may be designed and represented using computer files (such as RTL, GDSII, GERBER, etc.). The computer files may be stored on computer-readable media. Some or all such files may be provided to fabrication handlers who fabricate devices based on such files. Resulting products include wafers that are then cut into die and packaged into integrated circuits (or “chips”). The integrated circuits are then employed in electronic devices, such as one or more of the first electronic device 104 of FIG. 1, the second electronic device 180 of FIG. 1, or the electronic device 600 of FIG. 6.

The various illustrative logical blocks, configurations, modules, circuits, and algorithm steps described in connection with the examples disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, but such implementation decisions should not be interpreted as causing a departure from the scope of the present disclosure.

One or more operations of a method or algorithm described herein may be embodied directly in hardware, in a software module executed by a processor, or in a combination of the two. For example, one or more operations of the methods 400, 500 of FIGS. 4 and 5 may be initiated, controlled, or performed by a field-programmable gate array (FPGA) device, an application-specific integrated circuit (ASIC), a processing unit such as a central processing unit (CPU), a digital signal processor (DSP), a controller, another hardware device, a firmware device, or a combination thereof. A software module may reside in random access memory (RAM), magnetoresistive random access memory (MRAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transitory storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed examples is provided to enable a person skilled in the art to make or use the disclosed examples. Various modifications to these examples will readily apparent to those skilled in the art, and the principles defined herein may be applied to other examples without departing from the scope of the disclosure. Thus, the present disclosure is not intended to be limited to the examples shown herein but is to be accorded the widest scope possible consistent with the principles and novel features as defined by the following claims.

What is claimed is:

1. A method of operation of an electronic device, comprising:
in response to a number of electronic devices of a wireless network being less than a threshold number, generating a first message at a first electronic device, the first message indicating particular sub-channels of a transmission band that are to be used for a transmission in a single user (SU) mode of operation to a second electronic device;
sending the first message to the second electronic device, the first message indicating that a second message is to be sent to the second electronic device using the particular sub-channels; and
sending the second message to the second electronic device via the transmission using the particular sub-channels, wherein the transmission band includes a first frequency range corresponding to a first sub-channel of the particular sub-channels, a second frequency range corresponding to a second sub-channel of the particular sub-channels, and a third frequency range corresponding to a third sub-channel of the particular sub-channels, and wherein the second frequency range is adjacent to the first frequency range and the third frequency range.

2. The method of claim 1, further comprising avoiding at least one sub-channel of the transmission band based on an indication of one or more radar signals detected using a radar detection circuit.

3. The method of claim 1, wherein the particular sub-channels are associated with interference less than an interference threshold.

4. The method of claim 1, further comprising:
prior to generating the first message:
performing a scanning process to detect signals associated with a plurality of sub-channels that includes the particular sub-channels and at least one other sub-channel; and
based on the signals, determining an energy value for each of the plurality of sub-channels.

5. The method of claim 4, further comprising:
determining that the energy values associated with the particular sub-channels are less than an interference threshold; and
determining that the energy value associated with the at least one other sub-channel exceeds the interference threshold.

6. The method of claim 5, wherein determining that the energy values associated with the particular sub-channels are less than the interference threshold includes squaring amplitudes of the signals to generate the energy values and comparing the energy values to a threshold energy value corresponding to the interference threshold.

7. The method of claim 1, further comprising interleaving data of the second message among the particular sub-channels.

8. The method of claim 7, further comprising:
partitioning the data into a distinct data stream for each of the particular sub-channels; and
assigning bits of each distinct data stream to the particular sub-channel corresponding to the distinct data stream.

9. The method of claim 7, further comprising:
partitioning the data into a distinct data stream for each group of adjacent sub-channels of the particular sub-channels; and
assigning bits of each distinct data stream to the group corresponding to the distinct data stream.

10. The method of claim 7, further comprising assigning bits of the data as a single data stream to the particular sub-channels.

11. The method of claim 1, wherein the first message includes a preamble message having a bitmap, the bitmap including a bit for each sub-channel of the transmission band.

12. The method of claim 11, wherein the bitmap further includes one or more additional bits indicating whether sub-channel puncturing is enabled for the transmission.

13. The method of claim 1, wherein the first message and the second message are sent according to an Institute of Electronics and Electrical Engineers (IEEE) 802.11ax protocol.

14. The method of claim 13, wherein the second message is sent using an orthogonal frequency division multiplexing (OFDM) technique specified by the IEEE 802.11 ax protocol.

15. An apparatus comprising:
a sub-channel selection circuit configured to determine, in response to a number of electronic devices of a wireless network being less than a threshold number, particular sub-channels of a transmission band that are to be used for a transmission in a single user (SU) mode of operation to an electronic device of the wireless network, wherein the transmission band includes a first frequency range corresponding to a first sub-channel of the particular sub-channels, a second frequency range corresponding to a second sub-channel of the particular sub-channels, and a third frequency range corresponding to a third sub-channel of the particular sub-channels, and wherein the second frequency range is adjacent to the first frequency range and the third frequency range; and
a transmitter coupled to the sub-channel selection circuit, the transmitter configured to send a first message to the electronic device, the first message indicating that a second message is to be sent to the electronic device using the particular sub-channels, and to send the second message to the electronic device via the transmission using the particular sub-channels.

16. The apparatus of claim 15, further comprising an interleaver configured to interleave data of the second message among the particular sub-channels.

17. The apparatus of claim 16, wherein the interleaver is further configured to partition the data into a distinct data stream for each of the particular sub-channels and to assign bits of each distinct data stream to the particular sub-channel corresponding to the distinct data stream.

18. The apparatus of claim 16, wherein the interleaver is further configured to partition the data into a distinct data stream for each group of adjacent sub-channels of the particular sub-channels and to assign bits of each distinct data stream to the group corresponding to the distinct data stream.

19. The apparatus of claim 16, wherein the interleaver is further configured to assign bits of the data as a single data stream to the particular sub-channels.

20. The apparatus of claim 15, wherein the first message includes a preamble message having a bitmap, the bitmap including a bit for each of sub-channel of the transmission band, wherein a value of a bit for each sub-channel indicates whether the sub-channel is to be used for the transmission.

21. The apparatus of claim 20, wherein the bitmap further includes one or more additional bits indicating whether sub-channel puncturing is enabled for the transmission.

22. The apparatus of claim 15, further comprising a receiver configured to perform a scanning process to detect signals associated with a plurality of sub-channels that includes the particular sub-channels and at least one other sub-channel, and wherein the sub-channel selection circuit is further configured to determine, based on the signals, an energy value for each of the plurality of sub-channels.

23. The apparatus of claim 22, wherein the sub-channel selection circuit is further configured to determine that the energy values associated with the particular sub-channels indicate that interference associated with the particular sub-channels is less than an interference threshold and to determine that the energy value associated with the at least one other sub-channel exceeds the interference threshold.

24. The apparatus of claim 23, wherein the sub-channel selection circuit is further configured to determine that the energy values are less than the interference threshold by squaring amplitudes of the signals to generate the energy values and comparing the energy values to a threshold energy value corresponding to the interference threshold.

25. The apparatus of claim 15, wherein the transmitter is further configured to send the first message and the second message according to an Institute of Electronics and Electrical Engineers (IEEE) 802.11ax protocol.

26. The apparatus of claim 15, wherein the transmitter is further configured to send the second message using an orthogonal frequency division multiplexing (OFDM) technique specified by the IEEE 802.11ax protocol.

27. A method of operation of an electronic device, comprising:
receiving, from a first electronic device of a wireless network and in response to a number of electronic devices of the wireless network being less than a threshold number, a first message at a second electronic device of the wireless network, the first message indicating that a second message is to be sent using particular sub-channels of a transmission band; and
receiving the second message at the second electronic device from the first electronic device in a single user (SU) mode of operation and using the particular sub-channels, wherein the transmission band includes a first frequency range corresponding to a first sub-channel of the particular sub-channels, a second frequency range corresponding to a second sub-channel of the particular sub-channels, and a third frequency range corresponding to a third sub-channel of the particular sub-channels, and wherein the second frequency range is adjacent to the first frequency range and the third frequency range.

28. The method of claim 27, wherein at least one sub-channel of the transmission band is punctured based on one or more of an amount of interference associated with the at least one sub-channel or one or more radar signals associated with the at least one sub-channel.

29. An apparatus comprising:
a receiver configured to receive, in response to a number of electronic devices of a wireless network being less than a threshold number, a first message from an electronic device of the wireless network, the first message indicating that a second message is to be sent using particular sub-channels of a transmission band, the receiver further configured to receive the second message from the electronic device using the particular sub-channels and in a single user (SU) mode of operation, wherein the transmission band includes a first frequency range corresponding to a first sub-channel of the particular sub-channels, a second frequency range corresponding to a second sub-channel of the particular sub-channels, and a third frequency range corresponding to a third sub-channel of the particular sub-channels, and wherein the second frequency range is adjacent to the first frequency range and the third frequency range; and
a processor coupled to the receiver.

30. The apparatus of claim 29, wherein at least one sub-channel of the transmission band is punctured based on one or more of an amount of interference associated with the at least one sub-channel or one or more radar signals associated with the at least one sub-channel.
